(19) United States
(12) Patent Application Publication
(10) Pub. No.: US 2026/0089689 A1
(43) Pub. Date: Mar. 26, 2026

(54) METHODS AND APPARATUSES FOR RESOURCE SELECTION

(71) Applicant: Lenovo (Beijing) Limited, Beijing (CN)

(72) Inventors: Zhennian Sun, Beijing (CN); Haipeng Lei, Beijing (CN); Xiaodong Yu, Beijing (CN); Xin Guo, Beijing (CN)

(73) Assignee: Lenovo (Beijing) Limited, Beijing (CN)

(21) Appl. No.: 19/112,705

(22) PCT Filed: Nov. 11, 2022
(86) PCT No.: PCT/CN2022/131394

§ 371 Date: Mar. 18, 2025

(51) Int. Cl. H04W 72/02; H04W 72/0446

(52) U.S. Cl. CPC H04W 72/02; H04W 72/0446

(57) ABSTRACT

The present application relates to methods and apparatuses for resource selection. An embodiment of the present disclosure provides a UE for resource selection, comprising: a first layer; and a higher layer; wherein the first layer is to: receive a set of parameters from the higher layer associated with resource selection for a first transport block (TB); select a set of candidate multi-slot resources for the first TB, wherein a candidate multi-slot resource of the set of candidate multi-slot resources is selected based on a group of candidate RB sets associated with each candidate single-slot resource in the candidate multi-slot resource, or based on a selected resource for a second TB; and report the set of candidate multi-slot resources to the higher layer.

### TECHNICAL FIELD

The present disclosure relates to wireless communication, and particularly relates to methods and apparatuses for resource selection.

### BACKGROUND OF THE INVENTION

In an unlicensed spectrum, before any transmission, a base station (BS) or a user equipment (UE) may need to perform a listen before talk (LBT) procedure, and in the case that the LBT procedure is successful, the BS or the UE may perform the transmission, otherwise, the transmission cannot be performed. The BS or the UE may acquire a channel occupancy (CO) with the LBT type 1 procedure. The CO may be associated with a time duration, that is, the CO is acquired by the BS for a time duration; the CO may be associated with a frequency band, i.e., the CO is acquired by the BS for the frequency band, or the CO may be associated with both a time duration and a frequency band. Hereinafter in the present disclosure, the term “channel occupancy time (COT)” is used to describe the present disclosure, and persons skilled in the art are aware that the term “COT” and “CO” may also be used interchangeably.

In a sidelink unlicensed (SL-U) system, in order to reduce the need or frequency of UE performing LBT to access the channel once it has acquired a COT, multiple consecutive slot transmission (MCSt) has been supported. With MCSt, the UE may retain the COT, and perform data transmission as much as possible in the multiple consecutive slots.

Therefore, it is advantageous to provide solutions for resource selection for multiple consecutive slots.

### SUMMARY

An embodiment of the present disclosure provides a UE for resource selection, comprising: a first layer; and a higher layer; wherein the first layer is to: receive, from a higher layer, a set of parameters associated with resource selection for a first transport block (TB); select a set of candidate multi-slot resources for the first TB, wherein a candidate multi-slot resource of the set of candidate multi-slot resources is selected based on a group of candidate resource block (RB) sets associated with each candidate single-slot resource in the candidate multi-slot resource, or based on a selected resource for a second TB; and report the set of candidate multi-slot resources to the higher layer.

In some embodiments, the set of parameters includes at least one of the following: a number of sub-channels for a multiple consecutive slot transmission (MCSt); a number of consecutive slots for the MCSt.

In some embodiments, the set of parameters further includes: the selected resource for the second TB, wherein the selected resource for the second TB is associated with a resource selection window of the first TB.

In some embodiments, the first layer is further configured to: determine at least one group of candidate RB sets based on the number of sub-channels, wherein each group of candidate RB sets includes a minimum number of RB sets.

In some embodiments, in the case the minimum number of RB sets is more than one, RB sets in the each group of candidate RB sets are conservative in the frequency domain.

In some embodiments, the candidate multi-slot resource includes the number of consecutive candidate single-slot resources, and each candidate single-slot resource is in a same group of candidate RB sets.

In some embodiments, in the case that the candidate multi-slot resource is selected based on the selected resource for the second TB, a starting time of a candidate multi-slot resource is earlier than or equal to a starting time of the selected resource for the second TB, and an ending time of the candidate multi-slot resource is later than or equal to an ending time of the selected resource for the second TB.

In some embodiments, in the case that the candidate multi-slot resource is selected based on the selected resource for the second TB, the candidate multi-slot resource includes candidate single-slot resources for the first TB and the selected resource for the second TB, and all candidate single-slot resources for the first TB and the selected resource for the second TB are consecutive in a time domain.

In some embodiments, the candidate single-slot resource for the first TB and the selected resource for the second TB are in a same group of RB sets.

In some embodiments, in the case that a group of RB sets of the selected resource for the second TB includes all RB sets in a group of RB sets of candidate single-slot resources for the first TB, the selected resource for the second TB is located earlier than resources for the first TB in the time domain.

In some embodiments, in the case that a group of RB sets of candidate single-slot resources for the first TB includes all RB sets in a group of RB sets of the selected resource for the second TB, the selected resource for the second TB is later than resources for the first TB in the time domain.

In some embodiments, a reference signal received power (RSRP) threshold for resource selection is increased in the case that a total number of candidate multi-slot resources is smaller than a total number of multi-slot resources multiplied by a factor.

In some embodiments, the total number of candidate multi-slot resources refers to a first total number of candidate multi-slot resources determined based on the group of candidate RB sets associated with each candidate single-slot resource in each candidate multi-slot resource, or a second total number of candidate multi-slot resources determined based on the selected resource for the second TB, or a sum of the first total number and the second total number.

In some embodiments, in the case that the first total number is smaller than the total number of multi-slot resources multiplied by a factor, or in the case that the second total number is smaller than the total number of multi-slot resources multiplied by a factor, the RSRP threshold is increased.

In some embodiments, in the case that the first total number is smaller than the total number of multi-slot resources multiplied by a factor, the first layer is further configured to select the candidate multi-slot resources based on the selected resource for the second TB to obtain the second total number of candidate multi-slot resources from remaining multi-slot resources; and in the case that the sum of the first total number and the second total number is smaller than the total number of multi-slot resources multiplied by a factor, the RSRP threshold is increased.

In some embodiments, in the case that the second total number is smaller than the total number of multi-slot resources multiplied by a factor, the first layer is further configured to select the candidate multi-slot resources based on the group of candidate RB sets associated with each candidate single-slot resource in the candidate multi-slot resource, to obtain the first total number of candidate multi-slot resources from the remaining multi-slot resources; or in the case that the sum of the first total number and the second total number is smaller than the total number of multi-slot resources multiplied by a factor, the RSRP threshold is increased.

Another embodiment of the present disclosure provides a method for resource selection, comprising: receiving a set of parameters from the higher layer associated with resource selection for a first TB; selecting a set of candidate multi-slot resources for the first TB, wherein a candidate multi-slot resource of the set of candidate multi-slot resources is selected based on a group of candidate RB sets associated with each candidate single-slot resource in the candidate multi-slot resource, or based on a selected resource for a second TB; and reporting the set of candidate multi-slot resources to the higher layer

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system according to some embodiments of the present disclosure.

FIG. 2 illustrates a RB set configuration according to some embodiments of the present disclosure.

FIG. 3 illustrates a method for resource selection according to some embodiments of the present disclosure.

FIG. 4 illustrates a condition for taking the selected resource for another TB into the consideration during the resource selection procedure for a current TB according to some embodiments of the present disclosure.

FIG. 5A and FIG. 5B illustrate a method for resource selection according to some embodiments of the present disclosure.

FIG. 6A and FIG. 6B illustrate a method for resource selection according to some embodiments of the present disclosure.

FIG. 7 illustrates a method performed by a UE for resource selection according to some embodiments of the present disclosure.

FIG. 8 illustrates a simplified block diagram of an apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as a cellular telephone network, a time division multiple access (TDMA)-based network, a code division multiple access (CDMA)-based network, an orthogonal frequency division multiple access (OFDMA)-based network, a LTE network, a 3^{rd} generation partnership project (3GPP)-based network, LTE, LTE-Advanced (LTE-A), 3GPP 4G, 3GPP 5G NR, 3GPP Release 16 and onwards, a satellite communications network, a high altitude platform network, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

UE under an NR SL-U scenario may be referred to as an SL UE(s). An SL UE which transmits data on sidelink in an unlicensed spectrum may be referred to as a UE for transmitting, a transmitting UE, a transmitting SL UE, a Tx SL UE, a Tx UE, an SL Tx UE, an SL BWP Tx UE, a UE, or the like. An SL UE which receives data on sidelink in an unlicensed spectrum may be referred to as a UE for receiving, a receiving UE, a receiving SL UE, an Rx UE, an Rx SL UE, an SL Rx UE, a UE, or the like.

An SL UE(s) may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), internet of things (IoT) devices, personal computer (PC), game terminal, extended reality (XR) devices, or the like.

According to some embodiments of the present disclosure, an SL UE(s) may include a portable wireless communication device, a smart phone, a cellular telephone, a flip phone, a device having a subscriber identity module, a personal computer, a selective call receiver, or any other device that is capable of sending and receiving communication signals on a wireless network.

According to some embodiments of the present disclosure, an SL UE(s) may include wearable devices, such as smart watches, fitness bands, optical head-mounted displays, or the like. Moreover, an SL UE(s) may be referred to as a subscriber unit, a mobile, a mobile station, a user, a terminal, a mobile terminal, a wireless terminal, a fixed terminal, a subscriber station, a user terminal, or a device, or described using other terminology used in the art. An SL UE(s) may communicate directly with a BS(s) via communication signals.

A BS under an NR SL-U scenario may be referred to as a base unit, a base, an access point, an access terminal, a macro cell, a Node-B, an enhanced Node B (eNB), a gNB, a Home Node-B, a relay node, a device, a remote unit, or by any other terminology used in the art. A BS may be distributed over a geographic region. Generally, a BS is a part of a radio access network that may include one or more controllers communicably coupled to one or more corresponding base stations.

A BS may serve a number of SL UEs within a serving area, for example, a cell or a cell sector via a wireless communication link. A BS may communicate directly with one or more SL UEs via communication signals. For example, a BS may serve SL UEs within a macro cell.

Sidelink communication between a Tx UE and a receiving (Rx) UE under an NR SL-U scenario includes groupcast communication, unicast communication, or broadcast communication.

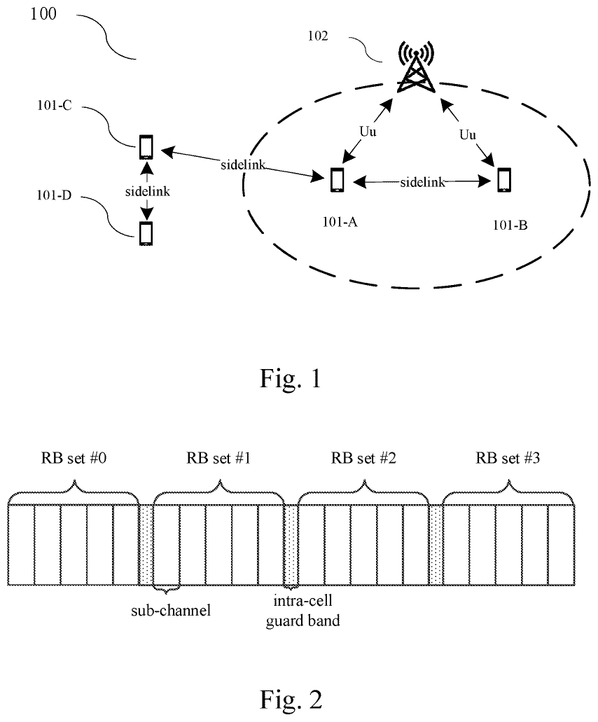

FIG. 1 illustrates wireless communication system 100 (e.g., an SL-U communication system) in accordance with some embodiments of the present disclosure.

As shown in FIG. 1, the wireless communication system 100 includes a base station (e.g., BS 102), and some UEs (e.g., UE 101-A, UE 101-B, UE 101-C, and UE 101-D). UE 101-A and UE 101-B are within the coverage of BS 102, and UE 101-C and UE 101-D are outside the coverage of BS 102. UE 101-A, UE 101-B, UE 101-C, and UE 101-D may perform sidelink unicast transmission, sidelink groupcast transmission, or sidelink broadcast transmission in an unlicensed spectrum, such as the SL BWP. UE 101-A, UE 101-B, UE 101-C, and UE 101-D may be referred to as an SL UE. It is contemplated that, in accordance with some other embodiments of the present disclosure, an SL-U communication system may include more BSs and more or fewer SL UEs.

In addition, although the SL UEs as shown in FIG. 1 are illustrated in the shape of a cellphone, it is contemplated that an SL communication system may include any type of UE (e.g., a roadmap device, a cell phone, a computer, a laptop, IoT device or other type of device) in accordance with some other embodiments of the present disclosure.

According to some embodiments of FIG. 1, UE 101-A may function as a Tx UE, and UE 101-B, UE 101-C, and UE 101-D may function as Rx UEs. UE 101-A may exchange SL messages with UE 101-B or UE 101-C through a sidelink using, for example, the NR technology or the LTE technology, through PC5 interface as defined in 3GPP documents. UE 101-A may transmit information or data to another UE(s) within the SL-U communication system through sidelink unicast, sidelink groupcast, or sidelink broadcast. For instance, UE 101-A may transmit data to UE 101-B in a sidelink unicast session. UE 101-A may transmit data to UE 101-B and UE 101-C in a groupcast group by a sidelink groupcast transmission session. Also, UE 101-A may transmit data to UE 101-B and UE 101-C by a sidelink broadcast transmission session.

Alternatively, according to some other embodiments of FIG. 1, UE 101-B or UE 101-C may function as a Tx UE and transmit information or data, and UE 101-A may function as an Rx UE and receive information or data from UE 101-B or UE 101-C.

Both UE 101-A and UE 101-B in the embodiments of FIG. 1 may transmit information to BS 102 and receive control information from BS 102, for example, via a Uu interface. BS 102 may define one or more cells, and each cell may have a coverage area. As shown in FIG. 1, both UE 101-A and UE 101-B are within the coverage of BS 102, while UE 101-C and UE 101-D are not.

UEs may operate in different modes. At least the following two sidelink resource allocation modes are defined for sidelink communication: resource allocation mode 1: a BS may schedule a sidelink resource(s) to be used by a UE for sidelink transmission(s); and resource allocation mode 2: a UE may determine a sidelink transmission resource(s) within sidelink resources configured by a BS or network, or pre-configured sidelink resources. In resource allocation mode 2, a BS may not schedule the sidelink resources for a UE. In FIG. 1, UE 101-A and UE 101-B may be in resource allocation mode 1, and UE 101-C and UE 101-D may be in resource allocation mode 2. In some other cases, UE 101-A and UE 101-B may also operate in resource allocation mode 2. Hereinafter in the present disclosure, “mode 1” may refer to resource allocation mode 1, and “mode 2” may refer to resource allocation mode 2.

For a UE in resource allocation mode 2, in order to perform the multiple consecutive slot transmission, the UE may select a multi-slot resource which includes multiple consecutive slots in the time domain. However, the sidelink resource selection for a UE in mode 2 is based on single slot, and there is no sidelink resource selection for a UE in mode 2 based on multiple consecutive slots.

Therefore, the enhancement of resource allocation mode 2 is needed to support MCSt. For MCSt, the number of consecutive slots may be 2 slots to 20 slots considering the maximum COT may be from 2 ms to 10 ms. When a larger number of consecutive slots is required, it may be difficult for a UE to select consecutive slots considering the reservation from other SL UEs and resources already selected by itself. To improve the data rate, one resource pool may be configured with multiple RB sets, and according to regulation for a transmission with multiple RB sets, the UE shall perform LBT on all the RB sets occupied by the transmission. For MCSt, the multiple RB sets may also be also considered which will be impact on the LBT procedure for multiple consecutive slots.

The present disclosure proposes some solutions for resource selection for MCSt as follows.

### Operation 1

The higher layer (for example, the MAC layer, or an entity of a UE that may perform the functions of a MAC layer) may trigger layer 1 (L1, for example, the physical layer, or an entity of a UE that may perform the functions of a physical layer) to report a set of candidate resources for MCSt, that is, a set of candidate multi-slot resources. The higher layer may also indicate a set of parameters for L1. The parameters may include at least one of the following:
1. The priority level associated with the transmission, which may be represented as: prio_{TX},
2. the remaining packet delay budget (PDB) of the transmission;
3. the number of sub-channels to be used for the transmission in a slot, which may be represented as: L_{subCH},
4. the resource reservation interval, P_{rsvp_TX}, in units of msec;
5. the number consecutive single-slot resources within the muti-slot resource, which may be represented as: Lₛₗₒₜₛ; or
6. selected resources for other TB or TBs. The transmission of other TB may be performed in a single slot or in multiple slots.

In some embodiment, only one set of parameters, (prio_{TX}, remaining PDB, L_{subCH} and P_{rsvp_TX}) may be provided for the resource selection procedure in L1. In some other embodiments, multiple set of parameters may be provided.

### Operation 2

After receiving the above parameters, L1 (for example, the physical layer) may determine a number of RB sets. In some embodiments, L1 may determine the minimum number of RB sets based on the number of sub-channels to be used for the transmission in a slot.

In an unlicensed spectrum, to improve the data rate, one resource pool may be configured with multiple channels. A channel may be also be referred to as a RB set, that is, one resource pool may be configured with multiple RB sets.

A transmission of a TB may occupy multiple RB sets, and before the transmission of the TB, the UE may perform a LBT procedure on each RB set, only when the LBT on all RB sets occupied by the transmission are successful, may the UE perform the transmission on the multiple RB sets. For the indicated number of sub-channels, which may be indicated by the higher layer to the physical layer, the UE may determine a number of RB sets (for example, the minimum number of RB sets) which could satisfy the transmission with the indicated number of sub-channels (i.e. L_{subCH}). It is supposed that each RB set may include N sub-channels, then the minimum number of RB sets may equal to [L_{subCH}/N], wherein “π” may refer to a round up function.

In the case that the minimum number of RB sets is more than one, the RB sets shall be continuous in the frequency domain to use the intra-cell guard band. The RB sets being continuous in the frequency domain is advantageous to avoid the uncertainty of multiple LBT procedures on multiple RB sets.

Based on the indicated number of sub-channels (i.e. L_{subCH}), L1 may determine many groups of candidate RB sets, and each group may include the minimum number of RB sets.

FIG. 2 illustrates a RB set configuration according to some embodiments of the present disclosure.

In FIG. 2, the resource pool may include four RB sets, RB set #0, RB set #1, RB set #2, and RB set #3. Each RB set may include five sub-channels. Between two RB sets, there is a guard band, which may be referred to as intra-cell guard band.

In the case that the number of sub-channels is less than or equal to five, i.e. L_{subCH}≤5, the minimum number of RB sets is 1, and the groups of candidate RB sets may include:
1. Group 1: RB set #0;
2. Group 2: RB set #1;
3. Group 3: RB set #2;
4. Group 4: RB set #3.

In the case that the number of sub-channels is larger than five and less than or equal to ten, i.e. 5<L_{subCH}≤10, the minimum number of RB sets is 2, and the groups of candidate RB sets may include the following:
1. Group 1: RB set #0 and RB set #1;
2. Group 2: RB set #1 and RB set #2; or
3. Group 3: RB set #2 and RB set #3.

In the case that the number of sub-channels is larger than ten and less than or equal to fifteen, i.e. 10<L_{subCH}≤15, the minimum number of RB sets is 3, and the groups of candidate RB sets may include the following:
1. Group 1: RB set #0, RB set #1, and RB set #2;
2. Group 2: RB set #1, RB set #2, and RB set #3.

In the case that the number of sub-channels is larger than fifteen and less than or equal to twenty, i.e. 15<L_{subCH}≤20, the minimum number of RB sets is 4, and the groups of candidate RB sets may include one group as following:
1. Group 1: RB set #0, RB set #1, RB set #2, and RB set #3.

Other numbers of the RB sets may be configured, for example, each RB set may include other numbers of sub-channels, e.g. 2 sub-channels, 3 sub-channels, etc., and there may be other numbers of RB sets, e.g. 5 RB sets, 6 RB sets, etc. L1 may determine the number of RB sets in a similar fashion.

### Operation 3

After determining the groups of candidate RB sets, which may include one or more RB sets, for each group of candidate RB sets, L1 may perform resource exclusion, e.g., exclude the resources reserved by other SL-UEs with a RSRP value higher than a RSRP threshold. After the resource exclusion, L1 may obtain a number of candidate single-slot resources.

In the present disclosure, the RSRP threshold for selecting the number of candidate single-slot resources is not increased based on the number of candidate single-slot resources.

### Operation 4

Based on the number of candidate single-slot resources, L1 may determine a number of candidate multi-slot resources, for example, N multi-slot resources.

### Operation 5

L1 may determine the candidate multi-slot resources which will be reported to the higher layer. The number consecutive single-slot resources within the multi-slot resource (denoted as Lslots for simplicity) may be indicated by the higher layer. In some other embodiments, the number of consecutive single-slot resources may be determined by UE implementation. In still some other embodiments, the number of consecutive single-slot resources may be determined by the restriction of maximum COT, that is, the number of consecutive single-slot resources may not exceed the maximum COT. In still some other embodiments, the number of consecutive single-slot resources may be determined by the remaining number of transmissions of the TB.

A SL UE in mode 2 may have multiple TBs to be transmitted. Resources for some TBs may have been selected, and the UE is selecting a set of multi-slot resources for a TB (referred to as TB1 for clarity). Depending on whether selected resource(s) for another TB, (referred to as TB2 for clarity), is taking into consideration or not during the resource selection procedure for TB1, there are following cases:

### Case 1

In case 1, the selected resource for TB2 is not considered during the resource selection procedure for TB1, a candidate multi-slot resource may be selected based on the group of candidate RB sets associated with each candidate single-slot resource. More specifically, in a candidate multi-slot resource, there may be the number consecutive single-slot resources (i.e. Lₛₗₒₜₛ consecutive single-slot resources in the time domain), and the Lₛₗₒₜₛ consecutive single-slot resources are in the same group of candidate RB sets.

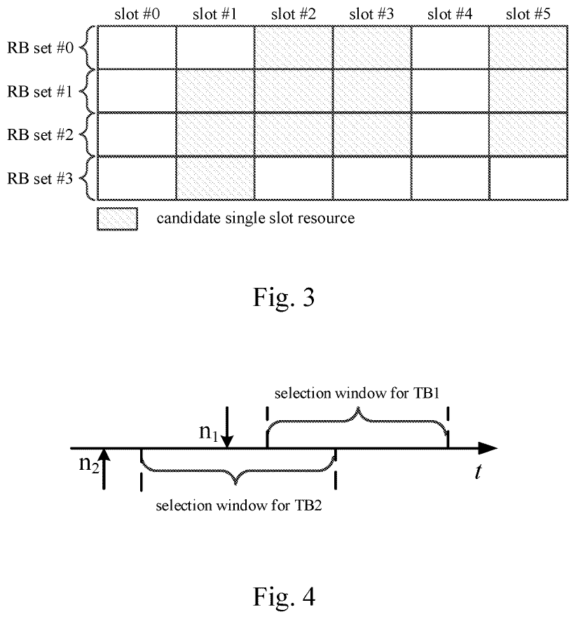

FIG. 3 illustrates a method for resource selection according to some embodiments of the present disclosure.

In FIG. 3, there are four RB sets, RB set #0, RB set #1, RB set #2, and RB set #3, and there are six slots, slot #0, slot #1, slot #2, slot #3, slot #4, and slot #5. According to the number of sub-channels indicated by the higher layer, 3 RB sets are needed. Accordingly, there may be two groups of candidate RB sets, i.e. group 1: RB set #0, RB set #1, and RB set #2; and group 2: RB set #1, RB set #2, and RB set #3. It is also determined that the number of consecutive single-slot resources is two.

There are four candidate single-slot resources, which are located in slot #1, slot #2, slot #3, and slot #5. Candidate single-slot resource in slot #1 and candidate single-slot resource in slot #2 are consecutive in the time domain, but they are not in the same group of candidate RB sets, thus the multi-slot resource including candidate single-slot resource in slot #1 and candidate single-slot resource in slot #2 are not a candidate multi-slot resource. Candidate single-slot resource in slot #3 and candidate single-slot resource in slot #5 are in the same group of candidate RB sets, but they are not consecutive in the time domain, thus the multi-slot resource including candidate single-slot resource in slot #3 and candidate single-slot resource in slot #5 are not a candidate multi-slot resource, either. Candidate single-slot resource in slot #2 and candidate single-slot resource in slot #3 are in the same group of candidate RB sets, and they are consecutive in the time domain, thus the multi-slot resource including candidate single-slot resource in slot #2 and candidate single-slot resource in slot #3 are a candidate multi-slot resource.

### Case 2

In case 2, the selected resource for another TB (e.g. TB2) is considered during the resource selection procedure for a current TB (e.g. TB1).

There is a condition for taking the selected resource for TB2 into the consideration during the resource selection procedure for TB1, that is, the selected resource for TB2 may be located in the resource selection window for TB1.

FIG. 4 illustrates a condition for taking the selected resource for another TB into the consideration during the resource selection procedure for a current TB according to some embodiments of the present disclosure.

The UE may have two TBs (e.g. TB1 and TB2) to be transmitted with different resource selection trigger instances. The resource selection for TB1 is triggered at time n1, and resource selection for TB2 is triggered at time n₂. It is supposed that UE has selected resource(s) for TB2 when performing the resource selection procedure for TB1. In the case that selected resource(s) for TB2 is located in the resource selection window of TB1, the UE may consider the selected resources for TB2 to ensure multiple consecutive slots in time domain including resources for both TB2 and TB1. In other words, in case 2, the UE may select a candidate multi-slot resource that includes both the resources for both TB2 and TB1 in the time domain. The number consecutive single-slot resources, i.e. Lₛₗₒₜₛ, may be larger than the number of slots of the resources for TB2.

Hereinafter in the case 2, the UE may have selected resource(s) for TB2, and may consider the selected resource(s) for TB2 for the resource selection procedure for TB1. It should be noted that although the selected resource(s) for one TB (i.e. TB2) is described, the selected resource(s) for more TBs may also be applied.

The higher layer may indicate that the selected resource for TB2 is in the selection window of TB1 to physical layer when the resource selection is triggered for TB1.

In case 2, whether a multi-slot resource being evaluated may be considered as a candidate multi-slot resource may depend on the following: 1): the location of the selected resource for TB2 in the time domain, and 2): the relation of the group of RB sets for transmission of TB1 (i.e. the group of RB sets for a multi-slot resource to be selected) and the group of RB sets for transmission of TB2 (i.e. the group of RB sets for the resource(s) have been selected).

In the time domain, in the case that the selected resource for TB2 is a multi-slot resource for MCSt, the length of selected multi-slot resource for TB2 shall not be larger than the number consecutive single-slot resources (i.e. Lₛₗₒₜₛ consecutive single-slot resources in the time domain), and the selected multi-slot resource for TB2 shall be fully located in the multi-slot resource being evaluated in the time domain. In other words, the starting time of a candidate multi-slot resource is earlier than or equal to the starting time of the selected resource for TB2, and an ending time of the candidate multi-slot resource is later than or equal to an ending time of the selected resource for the TB2.

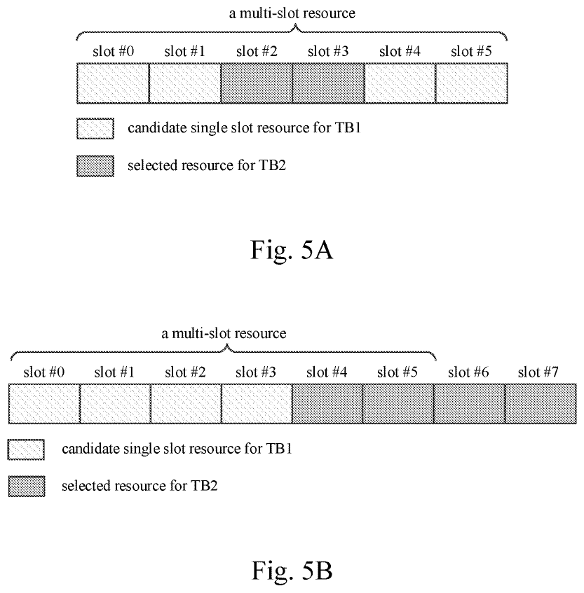

FIG. 5A illustrates a method for resource selection according to some embodiments of the present disclosure.

In FIG. 5A, the multi-slot resource being evaluated includes 6 slots, i.e. slot #0, slot #1, slot #2, slot #3, slot #4, and slot #5. The selected resources for TB2 are located at slot #2 and slot #3, the starting time of the multi-slot resource is at slot #0, which is earlier than the starting time of the selected resource for TB2, i.e. slot #2, and the ending time of the candidate multi-slot resource, i.e. slot #5 is later than the ending time of the selected resource for the TB2, i.e. slot #3. Therefore, the multi-slot resource may be considered as a candidate multi-slot resource.

FIG. 5B illustrates a method for resource selection according to some embodiments of the present disclosure.

In FIG. 5B, the multi-slot resource being evaluated includes 6 slots, i.e. slot #0 to slot #5. The selected resources for TB2 are located at slot #4 to slot #7, the starting time of the multi-slot resource is at slot #0, which is earlier than the starting time of the selected resource for TB2, i.e. slot #4, and the ending time of the candidate multi-slot resource, i.e. slot #5 is earlier than the ending time of the selected resource for the TB2, i.e. slot #7. Therefore, the multi-slot resource may not be considered as a candidate multi-slot resource.

In frequency domain, whether a multi-slot resource being evaluated may be considered as a candidate multi-slot resource may depend on the relation of the group of RB sets.

It is supposed that the group of RB sets for transmission of TB1 (i.e. the group of RB sets for a multi-slot resource to be selected) is referred to as group A, and the group of RB sets for transmission of TB2 (i.e. the group of RB sets for the resource(s) have been selected) is referred to as group B, based on the relation of the two groups, several scenarios are presented as follows: In some embodiments, the selected resource(s) for TB2 may be a single slot resource, or a multi-slot resource.

Scenario 1: group A (for TB1) and group B (for TB2) are the same group of RB sets.

The multi-slot resource being evaluated may be considered as a candidate multi-slot resource in the case that the following condition is fulfilled:
all the candidate single-slot resources for TB1 and selected resource(s) for TB2 are consecutive in the time domain.

For example, as shown in FIG. 5A, group A and group B are the same group of RB sets, the candidate single-slot resources for TB1, i.e. the candidate single-slot resources in slot #0, slot #1, slot #4, and slot #5, and the selected resource in slot #2 and slot #3 are consecutive in the time domain. Therefore, the multi-slot resource in FIG. 5A may be considered as a candidate multi-slot resource.

Scenario 2: group A (for TB1) and group B (for TB2) are different groups of RB sets, and group B includes all RB sets in group A.

The multi-slot resource being evaluated may be considered as a candidate multi-slot resource in the case that the following two conditions are fulfilled:
1. within the multi-slot resource being evaluated, selected resource(s) for TB2 is located earlier than the candidate single-slot resources for TB1 in the time domain, and
2. within the multi-slot resource being evaluated, all the candidate single-slot resources for TB1 and selected resource(s) for TB2 are consecutive in the time domain.

With the above condition 1, the UE may perform a LBT procedure on the group of RB sets (group B) with more RB sets than the other group (group A). If condition 1 is not fulfilled, for example, selected resource(s) for TB2 is located later than the candidate single-slot resources for TB1 in the time domain, the UE may perform a LBT procedure on the RB sets of group A (for TB1), which includes less RB sets than group B (for TB2). Since the resource is a multi-slot resource, the UE may not perform a LBT procedure after the transmission of TB1 and before the transmission of TB2. That is, the UE may only perform the LBT procedure on RB sets for the transmission of TB1, and LBT procedure on some RB sets for the transmission of TB2 may not be successful, therefore, the transmission of TB2 may fail.

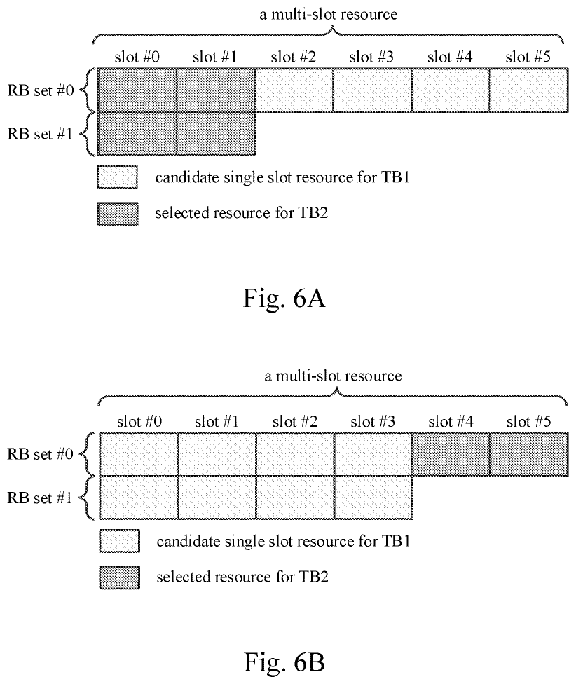

FIG. 6A illustrates a method for resource selection according to some embodiments of the present disclosure.

In FIG. 6A, the multi-slot resource includes 6 slots, i.e. slot #0, slot #1, slot #2, slot #3, slot #4, and slot #5. The selected resources for TB2 occupy a group of RB set including RB set #0 and RB set #1 in the frequency domain, and occupy slot #0 and slot #1 in the time domain. The candidate single-slot resources for TB1 occupy a group of RB set including RB set #0 in the frequency domain, and occupy slot #2 to slot #5 in the time domain. As can be seen, RB set #0 is included in the group of RB set occupied by the selected resources for TB2.

In the multi-slot resource, the selected resources for TB2 occupy slot #0 and slot #1, and the candidate single-slot resources for TB1 occupy slot #2 to slot #5, as can be seen, both the above two conditions are fulfilled. Therefore, the multi-slot resource in FIG. 6A may be considered as a candidate multi-slot resource.

In this way, before the transmission of TB2, the UE may perform a LBT procedure on both RB set #0 and RB set #1. Since the transmission of TB1 and TB2 are consecutive, the UE may not perform the LBT procedure after the transmission of TB2 and before the transmission of TB1.

In the case that resources selected for TB2 is located later than the candidate single-slot resources within the multi-slot resource being evaluated for TB1 in the candidate multi-slot resource in the time domain, before the transmission of TB1, the UE may perform a LBT procedure on RB set #0. Since the transmission of TB1 and TB2 are consecutive, the UE may not perform the LBT procedure after the transmission of TB1 and before the transmission of TB2. However, it is unclear whether RB set #1 is occupied by other devices or not, which may render transmission failure of TB2. In this case, the multi-slot resource may not be considered as a candidate multi-slot resource.

Scenario 3: group A (for TB1) and group B (for TB2) are different groups of RB sets, and group A includes all RB sets in group B.

The multi-slot resource being evaluated may be considered as a candidate multi-slot resource in the case that the following two conditions are fulfilled:
1. within the multi-slot resource being evaluated, candidate single-slot resources for TB1 is located earlier than the selected resources for TB2 in the time domain, and
2. within the multi-slot resource being evaluated, all the candidate single-slot resources for TB1 and selected resource(s) for TB2 are consecutive in the time domain.

With the above condition 1, the UE may perform a LBT procedure on the group of RB sets (group A) with more RB sets than the other group (group B). If condition 1 is not fulfilled, for example, selected resource(s) for TB1 is located later than the candidate single-slot resources for TB2 in the time domain, the UE may perform a LBT procedure on the RB sets of group B (for TB2), which includes less RB sets than group A (for TB1). Since the resource is a multi-slot resource, the UE may not perform a LBT procedure after the transmission of TB2 and before the transmission of TB1. That is, the UE may only perform the LBT procedure on RB sets for the transmission of TB2, and LBT procedure on some RB sets for the transmission of TB1 may not be successful, therefore, the transmission of TB1 may fail.

FIG. 6B illustrates a method for resource selection according to some embodiments of the present disclosure.

In FIG. 6B, the multi-slot resource includes 6 slots, i.e. slot #0, slot #1, slot #2, slot #3, slot #4, and slot #5. The selected resources for TB2 occupy a group of RB set including RB set #0 in the frequency domain, and occupy slot #4 and slot #5 in the time domain. The candidate single-slot resources for TB1 occupy a group of RB set including RB set #0 and RB set #1, and occupy slot #0 to slot #3. As can be seen, RB set #0 is included in the group of RB set occupied by the selected resources for TB1.

In the multi-slot resource, the selected resources for TB2 occupy slot #4 and slot #5, and the candidate single-slot resources for TB1 occupy slot #0 to slot #3, as can be seen, both the above two conditions are fulfilled. Therefore, the multi-slot resource being evaluated in FIG. 6B may be considered as a candidate multi-slot resource.

In this way, before the transmission of TB1, the UE may perform a LBT procedure on both RB set #0 and RB set #1. Since the transmission of TB1 and TB2 are consecutive, the UE may not perform the LBT procedure after the transmission of TB1 and before the transmission of TB2.

In the case that resources selected for TB2 is located earlier than the candidate single-slot resources within the multi-slot resource being evaluated for TB1 in the candidate multi-slot resource in the time domain, before the transmission of TB2, the UE may perform a LBT procedure on RB set #0. Since the transmission of TB1 and TB2 are consecutive, the UE may not perform the LBT procedure after the transmission of TB2 and before the transmission of TB1. However, it is unclear whether RB set #1 is occupied by other devices or not, which may render the transmission failure of TB1. In this case, the multi-slot resource may not be considered as a candidate multi-slot resource.

Based on the above, among the number of candidate multi-slot resources, the UE may select a set of candidate multi-slot resources for the first TB alone (case 1); or selected a set of candidate multi-slot resources for the first TB based on the selected resources for the second TB (case 2).

In some embodiments, L1 may report the set of candidate multi-slot resources, where a candidate multi-slot resource consists of a set of single-slot resources that are consecutive in time.

In some cases, the selected set of candidate multi-slot resources may not be enough to avoid the resource collision. For MCSt configuration, a factor, which may be represented as: Y, may be introduced, to ensure that there are enough multi-slot resources to avoid the resource collision. In some embodiments, the value of Y may be 0.1, 0.2, 0.3, etc.

Based on the above two cases in above operation 5, there may be different numbers of multi-slot resources, and the present disclosure proposes several options as follows:

### Option A: At Least One of Case 1 or Case 2

Based on case 1: L1 may select a first number of candidate multi-slot resources (which may be represented as M1) from the number of multi-slot resources (e.g. N multi-slot resources), based on the above case 1. That is, the first number of candidate multi-slot resources is selected for the transmission of the current TB (i.e. TB1). In the case that the first number of candidate multi-slot resources is not smaller than the number of multi-slot resources multiplied by a factor, i.e. MI≥N×Y, it is considered that there are enough multi-slot resources, and the RSRP threshold is maintained. Otherwise, i.e. M1<N×Y, it is considered that there are not enough multi-slot resources, and the RSRP threshold is increased.

Based on case 2: L1 may select a second number of candidate multi-slot resources (which may be represented as M2) from the number of multi-slot resources (e.g. N multi-slot resources), based on the above case 2. That is, the second number of candidate multi-slot resources is selected for the transmission of the current TB (i.e. TB1), and the transmission of another TB with selected resources (i.e. TB2). In the case that the second number of candidate multi-slot resources is not smaller than the number of multi-slot resources multiplied by a factor, i.e. M2≥N×Y, it is considered that there are enough multi-slot resources, and the RSRP threshold is maintained. Otherwise, i.e. M2<N×Y, it is considered that there are not enough multi-slot resources, and the RSRP threshold is increased.

Based on both case 1 and case 2: L1 may select a third number of candidate multi-slot resources (which may be represented as M1′) from the number of multi-slot resources (e.g. N multi-slot resources), based on the above case 1 and case 2. That is, L1 may determine whether a multi-slot resource being evaluated is considered as a candidate multi-slot resource based on both case 1 and case 2. The multi-slot resource being evaluated may be a candidate multi-slot resource in the case it is considered as a candidate multi-slot resource based on case 1, or it is considered as a candidate multi-slot resource based on case 2. The multi-slot resource being evaluated may not be a candidate multi-slot resource in the case it is not considered as a candidate multi-slot resource based on case 1, and it is not considered as a candidate multi-slot resource based on case 2.

In the case that the third number of candidate multi-slot resources is not smaller than the number of multi-slot resources multiplied by a factor, i.e. M1′≥N×Y, it is considered that there are enough multi-slot resources, and the RSRP threshold is maintained. Otherwise, i.e. M1′<N×Y, it is considered that there are not enough multi-slot resources, and the RSRP threshold is increased.

### Option B: Case 1 Is Prioritized Over Case 2

In this option, the UE (for example, L1) may first select a first number of candidate multi-slot resources (which may be represented as M1) from the number of multi-slot resources (e.g. N multi-slot resources), based on the above case 1. In the case that the first number of candidate multi-slot resources is not smaller than the number of multi-slot resources multiplied by a factor, i.e. M1≥N×Y, it is considered that there are enough multi-slot resources, and the RSRP threshold is maintained. Otherwise, i.e. M1<N×Y, it is considered that there are not enough multi-slot resources; the UE may select a second number of candidate multi-slot resources (which may be represented as M3) from the remaining number of multi-slot resources (e.g. N−M1 multi-slot resources). In the case that the sum of the first number and the second number is not smaller than the number of multi-slot resources multiplied by the factor, i.e. M1+M3>N×Y, it is considered that there are enough multi-slot resources, and the RSRP threshold is maintained. Otherwise, i.e. M1+M3<N×Y, it is considered that there are enough multi-slot resources, and the RSRP threshold is maintained.

### Option C: Case 2 Is Prioritized Over Case 1

In this option, the UE (for example, L1) may first select a second number of candidate multi-slot resources (which may be represented as M2) from the number of multi-slot resources (e.g. N multi-slot resources), based on the above case 2. In the case that the second number of candidate multi-slot resources is not smaller than the number of multi-slot resources multiplied by a factor, i.e. M2≥N×Y, it is considered that there are enough multi-slot resources, and the RSRP threshold is maintained. Otherwise, i.e. M2<N×Y, it is considered that there are not enough multi-slot resources; the UE may select a first number of candidate multi-slot resources (which may be represented as M4) from the remaining number of multi-slot resources (e.g. N−M2 multi-slot resources). In the case that the sum of the first number and the second number is not smaller than the number of multi-slot resources multiplied by the factor, i.e. M2+M4>N×Y, it is considered that there are enough multi-slot resources, and the RSRP threshold is maintained. Otherwise, i.e. M2+M4<N×Y, it is considered that there are enough multi-slot resources, and the RSRP threshold is maintained.

For all the above options, after the RSRP threshold being increased, the UE may repeat the resource selection procedure; in particular, the UE may select the candidate single-slot resources based on the increased RSRP threshold, select a number of multi-slot resources, and select a set of candidate multi-slot resources based on the above case 1 or case 2.

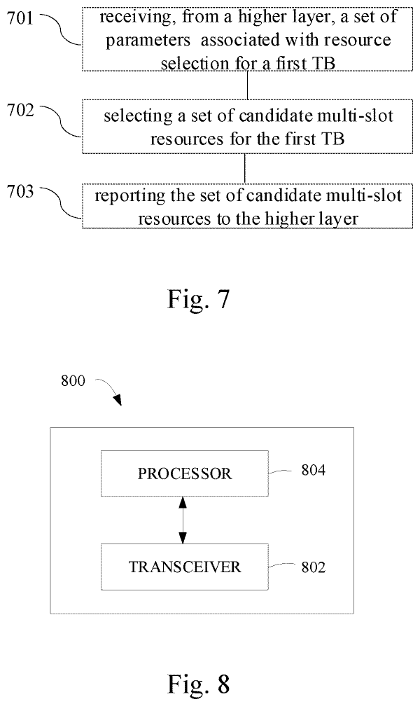

FIG. 7 illustrates a method performed by a UE for resource selection according to some embodiments of the present disclosure.

In operation 701, L1, for example, the physical layer may receive, from the higher layer (e.g. the MAC layer), a set of parameters associated with resource selection for a first TB. In operation 702, L1 may select a set of candidate multi-slot resources for the first TB, wherein a candidate multi-slot resource of the set of candidate multi-slot resources is selected based on a group of candidate RB sets associated with each candidate single-slot resource in the candidate multi-slot resource, or based on a selected resource for a second TB. In operation 703, L1 may report the set of candidate multi-slot resources to the higher layer.

In some embodiments, the set of parameters includes at least one of the following: a number of sub-channels for a multiple consecutive slot transmission (MCSt); a number of consecutive slots for the MCSt. For example, the higher layer may indicate the number of sub-channels e.g. L_{subCH} to the physical layer, and may also indicate the number consecutive single-slot resources within the multi-slot resource, e.g. Lₛₗₒₜₛ, to the physical layer.

In some embodiments, the set of parameters further includes: the selected resource for the second TB, wherein the selected resource for the second TB is associated with a resource selection window of the first TB. For example, in the above case 2, the higher layer may indicate the selected resource for the second TB to the physical layer.

In some embodiments, the first layer is further configured to: determine at least one group of candidate RB sets based on the number of sub-channels, wherein each group of candidate RB sets includes a minimum number of RB sets. In some embodiments, in the case the minimum number of RB sets is more than one, RB sets in the each group of candidate RB sets are conservative in the frequency domain.

In some embodiments, the candidate multi-slot resource includes the number of consecutive candidate single-slot resources, and each candidate single-slot resource is in a same group of candidate RB sets. For example, each candidate single-slot resource may be in a group including RB set #0 and RB set #1.

In some embodiments, in the case that the candidate multi-slot resource is selected based on the selected resource for the second TB, a starting time of a candidate multi-slot resource is earlier than or equal to a starting time of the selected resource for the second TB, and an ending time of the candidate multi-slot resource is later than or equal to an ending time of the selected resource for the second TB. For another example, as shown in FIG. 6A, the starting time of a candidate multi-slot resource is equal to the starting time of the selected resource for the second TB, and the ending time of the candidate multi-slot resource is later than the ending time of the selected resource for the second TB.

In some embodiments, in the case that the candidate multi-slot resource is selected based on the selected resource for the second TB, the candidate multi-slot resource includes candidate single-slot resources for the first TB and the selected resource for the second TB, and all candidate single-slot resources for the first TB and the selected resource for the second TB are consecutive in a time domain. For example, as shown in FIG. 6A, the candidate multi-slot resource includes candidate single-slot resources for the first TB and the selected resource for the second TB, and all candidate single-slot resources for the first TB (at slot #2 to slot #5) and the selected resource for the second TB (at slot #0 and slot #1) are consecutive in a time domain.

In some embodiments, the candidate single-slot resource for the first TB and the selected resource for the second TB are in a same group of RB sets. For another example, as shown in FIG. 5A, candidate single-slot resource for the first TB and the selected resource for the second TB are in the same RB set.

In some embodiments, in the case that a group of RB sets of the selected resource for the second TB includes all RB sets in a group of RB sets of candidate single-slot resources for the first TB, the selected resource for the second TB is located earlier than resources for the first TB in the time domain. For example, as shown in FIG. 6A, the selected resource for TB2 includes all RB sets in a group of RB sets of candidate single-slot resources for TB1, the selected resource for TB2 is located earlier than resources for TB1 in the time domain.

In some embodiments, in the case that a group of RB sets of candidate single-slot resources for the first TB includes all RB sets in a group of RB sets of the selected resource for the second TB, the selected resource for the second TB is later than resources for the first TB in the time domain. For example, as shown in FIG. 6B, a group of RB sets of candidate single-slot resources for TB1 includes all RB sets in a group of RB sets of the selected resource for TB2, the selected resource for TB1 is located earlier than resources for TB2 in the time domain.

In some embodiments, a RSRP threshold for resource selection is increased in the case that a total number of candidate multi-slot resources is smaller than a total number of multi-slot resources multiplied by a factor.

In some embodiments, the total number of candidate multi-slot resources refers to a first total number of candidate multi-slot resources determined based on the group of candidate RB sets associated with each candidate single-slot resource in each candidate multi-slot resource, or a second total number of candidate multi-slot resources determined based on the selected resource for the second TB, or a sum of the first total number and the second total number.

In some embodiments, in the case that the first total number is smaller than the total number of multi-slot resources multiplied by a factor, or in the case that the second total number is smaller than the total number of multi-slot resources multiplied by a factor, the RSRP threshold is increased. For example, the above solution described in option A.

In some embodiments, in the case that the first total number is smaller than the total number of multi-slot resources multiplied by a factor, the first layer is further configured to select the candidate multi-slot resources based on the selected resource for the second TB to obtain the second total number of candidate multi-slot resources from remaining multi-slot resources; and in the case that the sum of the first total number and the second total number is smaller than the total number of multi-slot resources multiplied by a factor, the RSRP threshold is increased. For example, the above solution described in option B.

In some embodiments, in the case that the second total number is smaller than the total number of multi-slot resources multiplied by a factor, the first layer is further configured to select the candidate multi-slot resources based on the group of candidate RB sets associated with each candidate single-slot resource in the candidate multi-slot resource, to obtain the first total number of candidate multi-slot resources from the remaining multi-slot resources; or in the case that the sum of the first total number and the second total number is smaller than the total number of multi-slot resources multiplied by a factor, the RSRP threshold is increased. For example, the above solution described in option C.

FIG. 8 illustrates a simplified block diagram of an apparatus according to some embodiments of the present disclosure.

As shown in FIG. 8, an example of the apparatus 800 may include at least one processor 804 and at least one transceiver 802 coupled to the processor 804. The apparatus 800 may be a UE, or any other device with similar functions.

Although in this figure, elements such as the at least one transceiver 802 and processor 804 are described in the singular, the plural is contemplated unless a limitation to the singular is explicitly stated. In some embodiments of the present disclosure, the transceiver 802 may be divided into two devices, such as a receiving circuitry and a transmitting circuitry. In some embodiments of the present disclosure, the apparatus 800 may further include an input device, a memory, and/or other components. In still some other embodiments, the apparatus 800 may include entities, functions or means for performing the functions of a higher layer, e.g. a MAC layer, and L1, e.g. a physical layer.

In some embodiments of the present disclosure, the apparatus 800 may be a UE. The transceiver 802 and the processor 804 may interact with each other so as to perform the operations of the UE described in any of FIGS. 1-7.

In some embodiments of the present disclosure, the apparatus 800 may further include at least one non-transitory computer-readable medium.

For example, in some embodiments of the present disclosure, the non-transitory computer-readable medium may have stored thereon computer-executable instructions to cause the processor 804 to implement the method with respect to the UE as described above. For example, the computer-executable instructions, when executed, cause the processor 804 interacting with the physical layer or the MAC layer to perform the operations of the UE described in any of FIGS. 1-7.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE) for wireless communication, comprising:
a first layer;
at least one memory; and
at least one processor coupled with the at least one memory and configured to cause the first layer of the UE to:
receive, from a higher layer, a set of parameters associated with resource selection for a first transport block (TB);
select a set of candidate multi-slot resources for the first TB, wherein a candidate multi-slot resource of the set of candidate multi-slot resources is selected based on a group of candidate resource block (RB) sets associated with each candidate single-slot resource in the candidate multi-slot resource; and
report the set of candidate multi-slot resources to the higher layer.

2. The UE of claim 1, wherein the set of parameters includes at least one of:
a number of sub-channels for a multiple consecutive slot transmission (MCSt);
a number of consecutive slots for the MCSt; or
a selected resource for a second TB, wherein the selected resource for the second TB is associated with a resource selection window of the first TB.

3. The UE of claim 2, wherein the at least one processor is configured to cause the first layer of the UE to determine at least one group of candidate RB sets based on the number of sub-channels, wherein each group of candidate RB sets includes a minimum number of RB sets.

4. The UE of claim 3, wherein, if the minimum number of RB sets is more than one, the RB sets in the each group of candidate RB sets are conservative in frequency domain.

5. The UE of claim 3, wherein the candidate multi-slot resource includes a number of consecutive candidate single-slot resources, and each candidate single-slot resource is in a same group of candidate RB sets.

6. The UE of claim 1, wherein, if that the candidate multi-slot resource is selected based on a selected resource for a second TB, a starting time of a candidate multi-slot resource is earlier than or equal to a starting time of the selected resource for the second TB, and an ending time of the candidate multi-slot resource is later than or equal to an ending time of the selected resource for the second TB.

7. The UE of claim 1, wherein, if the candidate multi-slot resource is selected based on a selected resource for a second TB, the candidate multi-slot resource includes candidate single-slot resources for the first TB and the selected resource for the second TB, and all candidate single-slot resources for the first TB and the selected resource for the second TB are consecutive in a time domain.

8. The UE of claim 7, wherein the candidate single-slot resource for the first TB and the selected resource for the second TB are in a same group of RB sets.

9. The UE of claim 7, wherein, if a group of RB sets of the selected resource for the second TB includes all RB sets in a group of RB sets of candidate single-slot resources for the first TB, the selected resource for the second TB is located earlier than resources for the first TB in the time domain.

10. The UE of claim 7, wherein, if a group of RB sets of candidate single-slot resources for the first TB includes all RB sets in a group of RB sets of the selected resource for the second TB, the selected resource for the second TB is later than resources for the first TB in the time domain.

11. The UE of claim 1, wherein a reference signal received power (RSRP) threshold for resource selection is increased if a total number of candidate multi-slot resources is smaller than a total number of multi-slot resources multiplied by a factor.

12. The UE of claim 11, wherein the total number of candidate multi-slot resources is one of a first total number of candidate multi-slot resources determined based on the group of candidate RB sets associated with each candidate single-slot resource in each candidate multi-slot resource, or a second total number of candidate multi-slot resources determined based on the selected resource for a second TB, or a sum of the first total number and the second total number.

13. The UE of claim 12, wherein, if the first total number is smaller than the total number of multi-slot resources multiplied by a factor, or if the second total number is smaller than the total number of multi-slot resources multiplied by a factor, the RSRP threshold is increased.

14. The UE of claim 12, wherein:
if the first total number is smaller than the total number of multi-slot resources multiplied by a factor, the first layer is further configured to select the candidate multi-slot resources based on the selected resource for the second TB to obtain the second total number of candidate multi-slot resources from remaining multi-slot resources; and
if the sum of the first total number and the second total number is smaller than the total number of multi-slot resources multiplied by a factor, the RSRP threshold is increased.

15. A method performed by a user equipment (UE) for resource selection, the method comprising:
receiving, from a higher layer, a set of parameters associated with resource selection for a first transport block (TB);
selecting a set of candidate multi-slot resources for the first TB, wherein a candidate multi-slot resource of the set of candidate multi-slot resources is selected based on a group of candidate resource block (RB) sets associated with each candidate single-slot resource in the candidate multi-slot resource; and
reporting the set of candidate multi-slot resources to the higher layer.

16. The method of claim 15, wherein the set of parameters includes at least one of:
a number of sub-channels for a multiple consecutive slot transmission (MCSt);
a number of consecutive slots for the MCSt; or
a selected resource for a second TB, wherein the selected resource for the second TB is associated with a resource selection window of the first TB.

17. The method of claim 15, further comprising:
determining at least one group of candidate RB sets based on a number of sub-channels, wherein each group of candidate RB sets includes a minimum number of RB sets.

18. The method of claim 15, wherein the candidate multi-slot resource includes a number of consecutive candidate single-slot resources, and each candidate single-slot resource is in a same group of candidate RB sets.

19. The method of claim 15, wherein a reference signal received power (RSRP) threshold for resource selection is increased if a total number of candidate multi-slot resources is smaller than a total number of multi-slot resources multiplied by a factor.

20. A processor for wireless communication, comprising:
at least one controller coupled with at least one memory and configured to cause the processor to:
receive, from a higher layer, a set of parameters associated with resource selection for a first transport block (TB);
select a set of candidate multi-slot resources for the first TB, wherein a candidate multi-slot resource of the set of candidate multi-slot resources is selected based on a group of candidate resource block (RB) sets associated with each candidate single-slot resource in the candidate multi-slot resource; and
report the set of candidate multi-slot resources to the higher layer.
